(19) United States
(12) Patent Application Publication
(10) Pub. No.: US 2004/0262410 A1
(43) Pub. Date: Dec. 30, 2004

(54) Graphical thermostat and sensor

(76) Inventor: Gerry G. Hull, Atlanta, GA (US)

Correspondence Address: William R. Silverio, SUTHERLAND ASBILL & BRENNAN LLP, 999 Peachtree Street, NE, Atlanta, GA, 30309-3996, US

(21) Appl. No.: 10/823,486

(22) Filed: Apr. 12, 2004

Related U.S. Application Data
(60) Provisional application No. 60/462,293, filed on Apr. 11, 2003.

(51) Int. Cl. F23N 5/20; G05D 23/00; F25B 49/00; G05D 23/32

(52) U.S. Cl. 236/91 R; 62/126; 236/91 D; 236/94; 62/157

(57) ABSTRACT

A graphical thermostat and sensor permits a user to graphically control and customize heating and cooling start/stop times using a large LCD display. The display includes the presentation of a daily trend graph that lets a user quickly determine if the HVAC system is working properly. The large LCD display also shows a trend graph which illustrates when the HVAC system is scheduled to go unoccupied, and can be used to change the occupation/unoccupation schedule at the touch of a button. The thermostat also includes a communications jack that provides access to the HVAC control system for commissioning and maintenance.

### RELATED APPLICATION DATA

The present invention claims priority to U.S. Patent Application Ser. No. 60/462,293, titled “Graphical Thermostat and Sensor”, filed Apr. 11, 2003, the entire contents of which are incorporated herein by reference as if set forth fully herein.

### FIELD OF THE INVENTION

The present invention relates to a graphical thermostat and sensor, and more particularly to a networkable thermostat and sensor having a large LCD display and intuitive user interface.

### BACKGROUND OF THE INVENTION

Current thermal comfort controllers, or thermostats, have limited user interfaces that typically include a number of data input buttons and a small display. Thermostats often have setback capabilities which involves a programmed temperature schedule. Such a schedule is made up of a series of time-scheduled set-points. Each set-point includes a desired temperature and a desired time. Once programmed with this temperature schedule, the controller sets-up or sets-back the temperature accordingly. For example, a temperature schedule could be programmed so that in the winter months, a house is warmed to 72 degrees automatically at 6:00 a.m. when the family awakes, cools to 60 degrees during the day while the family is at work and at school, re-warms to 72 degrees at 4:00 p.m. and then cools a final time to 60 degrees after 11:00 p.m., while the family is sleeping. Such a schedule of lower temperatures during off-peak hours saves energy costs.

It is well known that users have difficulty using the current form of a user interface for thermostats because such an interface is not intuitive and is somewhat complicated to use. Therefore, users either do not utilize the energy saving programmable functions of the controller, or they do not change the schedule that is programmed by either the installer or that is the factory default setting. Another limitation of the current user interfaces for thermostats is that once programmed, the temperature schedule cannot be easily reviewed. Usually, the display is configured to show one set-point at a time in a numerical manner. Using the input buttons, the user must ‘page forward’ to the next set-point in the schedule or ‘page backward’ to the previous set-point.

Although the user can, with difficulty, determine the temperature schedule that is programmed into the controller, the user cannot determine how closely this temperature schedule was followed. Of course, when a new set-point determines that the controller should either raise or lower the temperature in a house or other building, the temperature does not immediately change to that new temperature. It can take some time for the room or building to warm up or cool down to the desired temperature. The thermostat typically tracks this information to allow adjustment to be easily made. At present, the user has no way of viewing this information and no way of correlating the temperature schedule with actual house temperatures.

What is therefore needed is a user interface for a thermostat in which the temperature schedule is more easily viewed and programmed. The user interface should also be able to compare the temperature schedule against the actual historical temperature over a period of time.

### SUMMARY OF THE INVENTION

According to one embodiment of the present invention, the graphical thermostat and sensor according to the present invention is a precision zone sensor, and permits a user to graphically control heating and cooling, including daily, weekly, monthly and customized HVAC start/stop times. The device includes a large LCD display and intuitive user interface that makes it easy to use, and includes the presentation of a daily trend graph that lets a user quickly determine if the HVAC system to which the thermostat and sensor is connected is working properly. The large LCD display shows a trend graph which illustrates when the HVAC system is scheduled to go unoccupied, and can be used to change the occupation/unoccupation schedule at the touch of a button. The graphical thermostat and sensor also functions as a zone sensor and is thus ideal for offices, schools, board rooms, reception areas, and any other locations where precision control, occupant flexibility, and smart appearance are important. The device also includes a hidden communications jack that provides access to the HVAC control system for commissioning and maintenance.

According to one aspect of the present invention, the LCD display of the graphical thermostat and sensor displays a graph of the zone temperature, heating set point, and cooling set point during normal operation. The LCD display and intuitive user controls allow the occupant to adjust heating set point, cooling set point, and occupancy start and stop time. Additionally, a scheduling interface may allow the occupant to program occupancy periods for weekdays, weekends, holidays, or any other time period. The device includes a precise 10K ohm thermistor with standard accuracy and less than 0.18° F. drift over a ten-year span. According to one aspect of the invention, the device also includes a hidden communication port which allows the thermostat and sensor to accept a laptop computer interface to connect to the HVAC control system. Therefore, test and balance procedures can be conducted through the graphical thermostat and sensor using a laptop computer. The graphical thermostat and sensor may also include, according to a preferred embodiment of the invention, a high speed data communication interface.

### BRIEF DESCRIPTION OF THE DRAWINGS

Having thus described the invention in general terms, reference will now be made to the accompanying drawings, which are not necessarily drawn to scale, and wherein:

FIG. 1A shows a perspective view of the graphical thermostat and sensor according to one embodiment of the invention.

FIG. 1B shows a perspective view of a graphical thermostat and sensor, according to another aspect of the invention.

FIG. 2A shows a bottom view of the graphical thermostat and sensor, according to one embodiment of the present invention.

FIG. 2B shows a front view of the graphical thermostat and sensor, according to one embodiment of the present invention.

FIG. 3 is a block diagram illustrating components of the graphical thermostat and sensor, according to one embodiment of the present invention.

FIGS. 4-16 illustrate, respectively, LCD screen displays presented by the LCD screen of the graphical thermostat and sensor, according to one embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

FIG. 1A shows a perspective view of a graphical thermostat and sensor 10, according to one embodiment of the present invention. The graphical thermostat and sensor 10 permits a user to graphically control heating and cooling using daily, weekly, monthly and customized HVAC start/stop times. The device includes a large LCD display and intuitive user interface that makes it easy to use, and includes the presentation of a daily trend graph that lets a user quickly determine if the HVAC system is working properly.

According to one embodiment of the present invention, the graphical thermostat and sensor 10 is sized such as it will mount on a standard 2-inch by 4-inch electrical box for easy installation. The graphical thermostat and sensor 10 preferably includes a low-profile case or enclosure such that it will not protrude far from a wall upon which it is mounted. The sensor 10 generally includes a display 12, a control knob 14 and a plurality of buttons 16. The display 12, which provides an easy-to-read graphical display and user interface, is preferably an LCD display, which may be a back-lit LCD screen. According to one aspect of the invention, the display 12 may be a touch-sensitive display that operates as a user input device. The display 12 may alternatively be an active matrix TFT display, plasma screen, or like screen as well known to those of skill in the art.

The control knob 14 and buttons 16 enable a user to provide input to the graphical thermostat and sensor 10. The control knob 14 is operable to rotate in the direction illustrated by arrows 15. The control knob may also be depressed inward as a selection feature. Preferably, the control knob 14 is positioned in the lower center of the graphical thermostat and sensor 10 case, and is preferably circular in shape. As illustrated in FIGS. 1A and 1B, the generally circular control knob 14 can comprise various shapes. For instance, the control knob 14 may be configured as a roller ball, as in FIG. 1A, or as a rotatable selector, as in FIG. 1B.

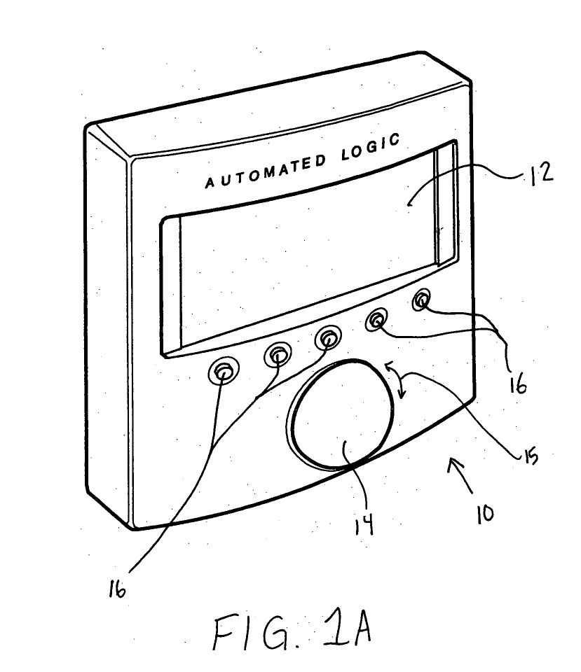

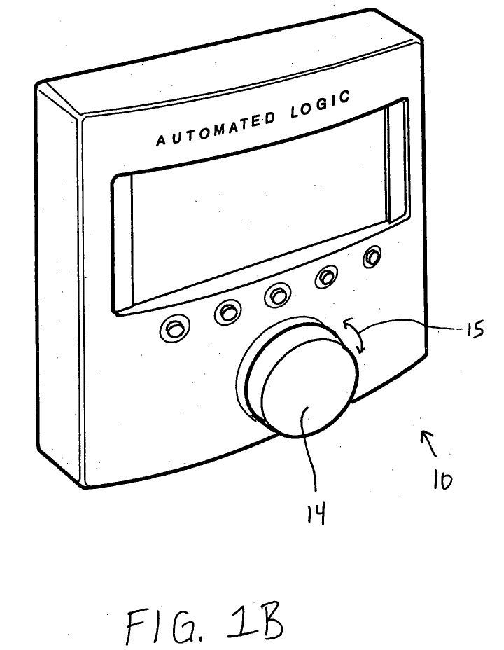

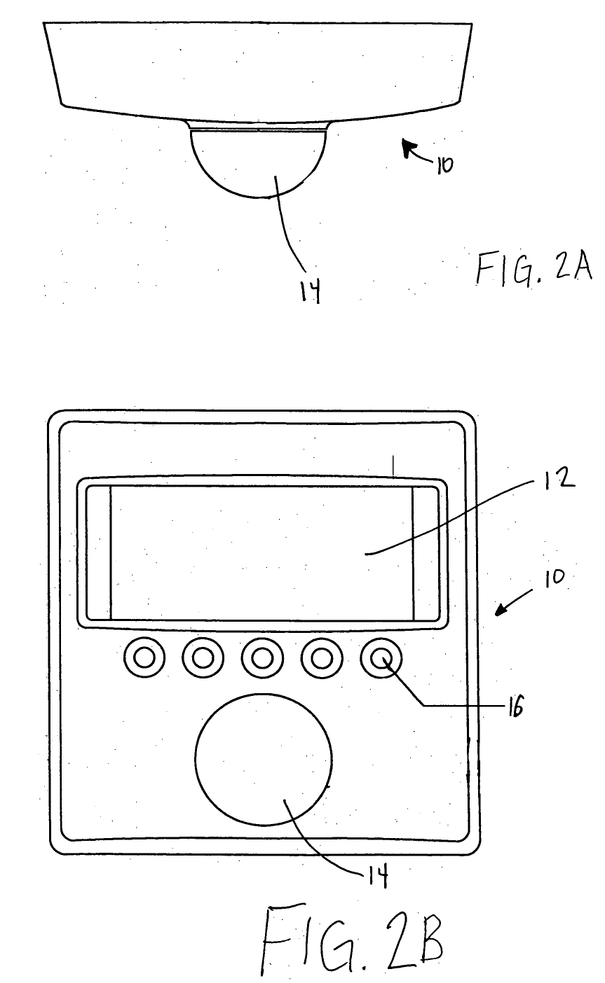

FIG. 2A shows a bottom view of the graphical thermostat and sensor 10 of FIG. 1A, and FIG. 2B shows a front view of the same graphical thermostat and sensor 10. As illustrated in FIG. 2B, the graphical thermostat and sensor 10 may include five buttons 16. As will be explained in detail with reference to FIGS. 4-16 below, these buttons are soft keys allowing a user to provide various inputs to the graphical thermostat and sensor 10. The function associated with each button is represented on the graphical LCD display 12 directly above each button. Although five buttons are illustrated, it will be appreciated by those of skill in the art that fewer or more buttons 16 may be used to effect the functions described herein. Additionally, it will be appreciated that the graphical thermostat and sensor 10 may operate without the use of buttons 16 where the LCD screen is a pressure-sensitive touch screen permitting a user to select one or more graphical buttons that perform the same function as the buttons 16.

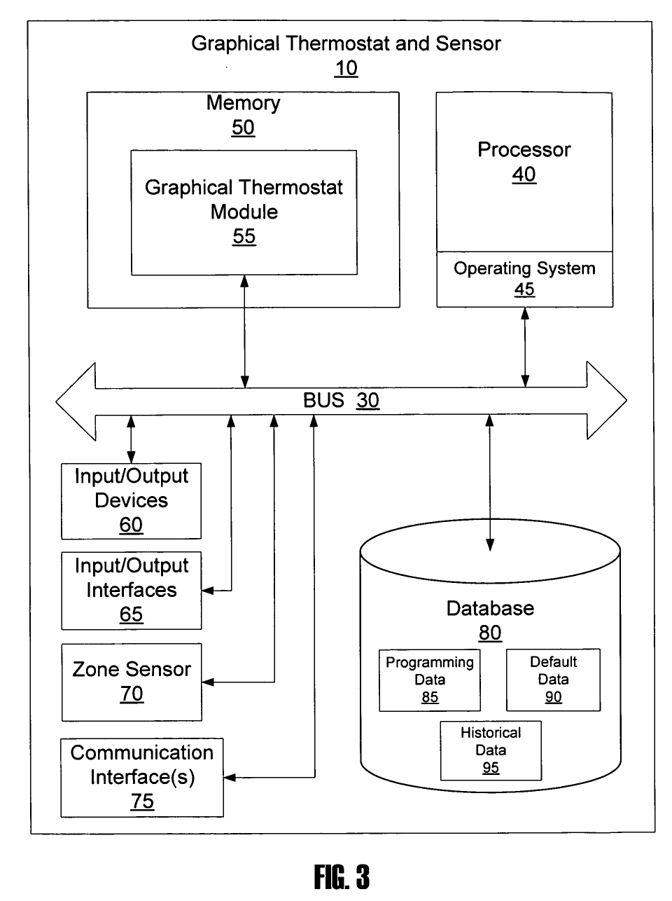

FIG. 3 shows a block diagram illustrating a graphical thermostat and sensor 10 according to one embodiment of the present invention. It will be appreciated that the systems and methods of the present invention are described below with reference to block diagrams and graphical user interface illustrations. It should be understood that the blocks of the block diagrams and the graphical user interfaces shown in the illustrative interfaces of FIGS. 4 through 16, as well as their functions, may be implemented by computer program instructions. These computer program instructions may be loaded onto a general purpose computer, special purpose computer, or other programmable data processing apparatus to produce a mechanism, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus, such as a thermostat, to function in a particular manner, such that the instructions stored in the computer-readable memory produce an article of manufacture including instruction means that implement the functions described herein with respect to the graphical user interfaces described with respect to FIGS. 4-16. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified herein. It will also be understood that each block of the block diagrams and the graphical user interface features and functions described herein can be implemented by special purpose hardware-based computer systems that perform the specified functions or steps, or combinations of special purpose hardware and computer instructions.

Referring again to FIG. 3, the graphical thermostat and sensor 10 generally includes a processor 40, operating system 45, memory 50, input/output devices 60, input/output interfaces 65, zone sensor 70, communications interface(s) 75, database 80 and bus 30. The bus 30 includes data and address lines to facilitate communication between the processor 40, operating system 45 and the other components within the sensor 10, including the graphical thermostat module 55, the input/output devices 60, input/output interfaces 65, and the database 80. The processor 40 executes the operating system 45, and together the processor 40 and operating system 45 are operable to execute functions implemented by the graphical thermostat and sensor 10, including software applications stored in the memory 50, as is well known in the art. Specifically, to implement the methods described in detail herein the processor 40 and operating system 45 are operable to execute the graphical thermostat module 55 stored within the memory 50.

It will be appreciated that the memory 50 in which the graphical thermostat module 55 resides may include random access memory, firmware, read-only memory, a hard disk drive, a floppy disk drive, a CD Rom drive, or optical disk drive, for storing information on various computer-readable media, such as a hard disk, a removable magnetic disk, or a CD-ROM disk. Generally, the graphical thermostat module 55 receives information input, stored or received by the graphical thermostat and sensor 15, including user input data 25, zone sensor 70 data, programming data 85, default data 90, and/or historical data 95. Using this information the graphical thermostat module 55 effects control of the HVAC system to which it is attached via the communication interface(s) 75, and generates the graphical user interfaces shown in the illustrative interfaces of FIGS. 4 through 16. These interfaces, as described in detail below, permit a user to graphically control heating and cooling using daily, weekly, monthly and customized HVAC start/stop times and to quickly ascertain if the HVAC system is working properly.

The processor 40 is in communication with the input/output (I/O) interfaces 65 to control I/O devices 60 of the graphical thermostat and sensor 10. Typical user I/O devices may include the LCD display 12, buttons 16, control knob 14, as well as any devices connected to the graphical thermostat and sensor 10 via one or more communication interfaces, including video displays, keyboards, sensors, or other input or output devices. The communication interface(s) 75 provide one or more I/O ports and/or one or more network interfaces that permit the graphical thermostat and sensor 10 to receive and transmit information via a network connection. For instance, according to one aspect of the invention, the graphical thermostat and sensor 10 may retrieve data from remote I/O devices or sources, such as via a LAN, WAN, the Internet, or the like, to implement the functions described herein. Therefore, the I/O interfaces 65 may also include a system, such as a modem, for effecting a connection to a communications network.

The database 80 of the graphical thermostat and sensor 10, which is connected to the bus 30 by an appropriate interface, may include random access memory, read-only memory, a hard disk drive, a floppy disk drive, a CD Rom drive, or optical disk drive, for storing information on various computer-readable media, such as a hard disk, a removable magnetic disk, or a CD-ROM disk. In general, the purpose of the database 80 is to provide non-volatile storage to the graphical thermostat and sensor 10. As shown in FIG. 3, the database includes one or more tables, segments or files within the database 80, including programming data 85, default data 90, and historical data 30, which is used by the graphical thermostat and sensor 10, and more particularly, the graphical thermostat module 55, to execute the functions described herein. More specifically, the programming data 85 includes user-input start and stop times, temperatures, days, weeks and customized schedules that the user may input using one or more of the graphical user interfaces described in detail below with reference to FIGS. 4-16.

The historical data includes historical temperature data as measured by the zone sensor 70 of the graphical thermostat and sensor 10. The historical data also stores past user programming information so that the historical temperature may be graphically compared on the display to the programmed temperature. The database 80 also includes default data, which may be used to operate the graphical thermostat and sensor 10 where no user-input programming data is applicable for a particular time period. According to one aspect of the invention, the default data may be used to operate an HVAC system to which the graphical thermostat and sensor 10 is attached in the most efficient manner in off hours, such as when a commercial building is not occupied.

It is important to note that the computer-readable media described above with respect to the memory 50 and database 80 could be replaced by any other type of computer-readable media known in the art. Such media include, for example, magnetic cassettes, flash memory cards, digital video disks, and Bernoulli cartridges. It will be also appreciated by one of ordinary skill in the art that one or more of the graphical thermostat and sensor 10 components may be located geographically remotely from other graphical thermostat and sensor 10 components. For instance, the programming data 85 may be located geographically remote from the graphical thermostat and sensor 10, such that programming data are accessed or retrieved from a remote source in communication with the graphical thermostat and sensor 10 via the communication interface(s) 75.

Furthermore, though illustrated individually in FIG. 3, each component of the graphical thermostat and sensor 10 may be combined with other components within the graphical thermostat and sensor 10 to effect the functions described herein. The functions of the present invention will next be described in detail with reference to graphical user interfaces permitting user-input temperature schedules and the display of historical temperature information. It will be understood that each illustrative graphical user interface shown in FIGS. 4 through 16 may be provided via the LCD screen 12 and implemented by computer program instructions loaded onto the graphical thermostat and sensor 10 as described above.

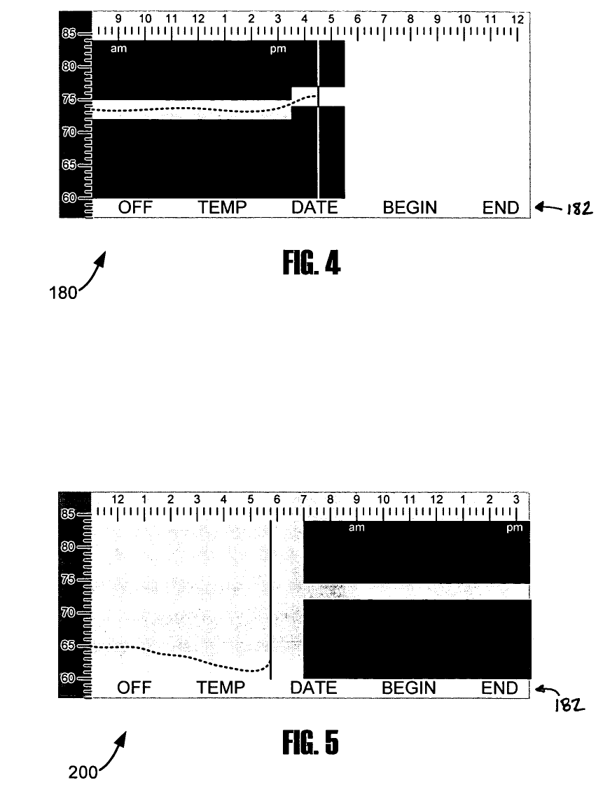

FIGS. 4 and 5 illustrate, respectively, illustrative P.M. and A.M. views presented by the LCD display 12 of the graphical thermostat and sensor 10. In FIG. 4 the display 180 shows temperature readings between 60° F. and 85° F. for all times between noon and midnight. Similarly, FIG. 5 shows a display 200 showing temperature readings between 60° F. and 85° F. for all times between midnight and noon. The shaded area, dotted line and vertical bar illustrated in both FIGS. 4 and 5 will be explained in greater detail below. The soft key functions 182 are illustrated along a lower row of the display 12, such that the user may select a button directly below each function to effect operation of each graphical user interface. The function of each soft key is described in detail below.

FIG. 6 shows a start interface 220 provided by the graphical thermostat and sensor 10. As illustrated in FIG. 6, the start interface 220 includes a vertical bar 230 illustrating the current time, as indicated by the time displayed at the intersection of the vertical bar 230 and the top of the LCD display 12. Therefore, the vertical bar 230 provides a quick visual reference as to the present time. For instance, as illustrated in FIG. 6 by the vertical bar 230, the current time is 4:30 p.m. FIG. 6 also shows, via a shaded area, the start and stop times that the graphical thermostat and sensor 10 controls the temperature of the HVAC system for its zone. According to the illustrative example of FIG. 6, the start time is 7 a.m. and the stop time is 5:30 p.m. because those times define the leftmost and rightmost boundaries of the shaded area. Within the shaded area there is also displayed a horizontal bar (i.e., an unshaded line) extending in FIG. 6 approximately from 7 a.m. to 3:30 p.m. and from 3:30 p.m. to 5:30 p.m. Because the vertical axis of the LCD display of the start interface 220 provides a range of temperatures (60-85 degrees), this horizontal bar indicates a preset temperature range of plus or minus one degree above, or plus or minus one degree below, the set temperature. Therefore, between 7 a.m. and 3:30 p.m., when the temperature is set at 74° F., the horizontal bar interrupts the shaded area from 73° F. to 75° F. When a user increases the temperature to 74° F. at 3:30 p.m., however, the horizontal bar increases to define a temperature zone from 74° F. to 75° F.

FIG. 6 also shows a dashed temperature tracking line that shows the actual temperature at each time period displayed by the LCD display 12. This temperature is stored as historical data as described with respect to FIG. 3, above. As shown in FIG. 6, the temperature starts at 65° F. and quickly increases to approximately 71° F. at 8 a.m. The temperature tracking line and the horizontal temperature bar together illustrate that the desired temperature is within a plus or minus one degree difference of the desired temperature, and thus the temperature tracking line falls within the horizontal temperature bar. This allows a user to quickly glance at the LCD display 12 and determine whether the desired temperature throughout the day is being maintained by the graphical thermostat and sensor 10 and HVAC system. This may be advantageous, for instance, where a commercial tenant or user of the graphical thermostat and sensor 10 pays for heating and air conditioning only when the actual temperature is close to the desired temperature set by the tenant or user. It will also be appreciated that the range illustrated by the horizontal temperature bar is configurable by a user such that the horizontal temperature bar will show a greater range in plus or minus degrees from the temperature at which the thermostat is set. Additionally, though the temperature and time axis are limited in what the display can show at any time, it will be appreciated that the display is operable to scroll to lower or higher temperatures, or to other time periods.

The start interface 220 of FIG. 6 is the default display of the graphical thermostat and sensor 10 during regular operation. To control the graphical thermostat and sensor 10 one or more of the five buttons 16 may be depressed. As illustrated in FIG. 6, the interface 220 includes one or more functions 240, 260, 280, 300 associated, respectively, with the one of more buttons 16. On any interface screen each button includes only one associated function. However, in the start interface 220, the Temp button 240 need not be depressed, as it is programmed to be a default setting. Therefore, a user can change the current temperature by rotating the control knob 14 right (to increase the current temperature) or left (to decrease the current temperature). Optionally, the control knob 14 may be depressed to lock in the selected temperature. The graphic display will illustrate the newly selected temperature by immediately moving the horizontal bar that defines the acceptable range around the selected temperature. Optionally, while the temperature is being selected, a temperature graphic may also be illustrated to the user.

From the start interface 220, the user can select the begin button 280, for instance, by pressing the button directly below ‘Begin’ on the LCD display 12. This feature is used to activate the occupied time if the current time is before the occupied time. For instance, in the illustrative example of FIG. 6, if the begin button 280 is depressed at 6 am, the leftmost boundary of the shaded area will extend to that time and the thermostat will begin to operate using the temperature programmed at the beginning of the normal operating time (in this example, the temperature that is set for the 7 am start time).

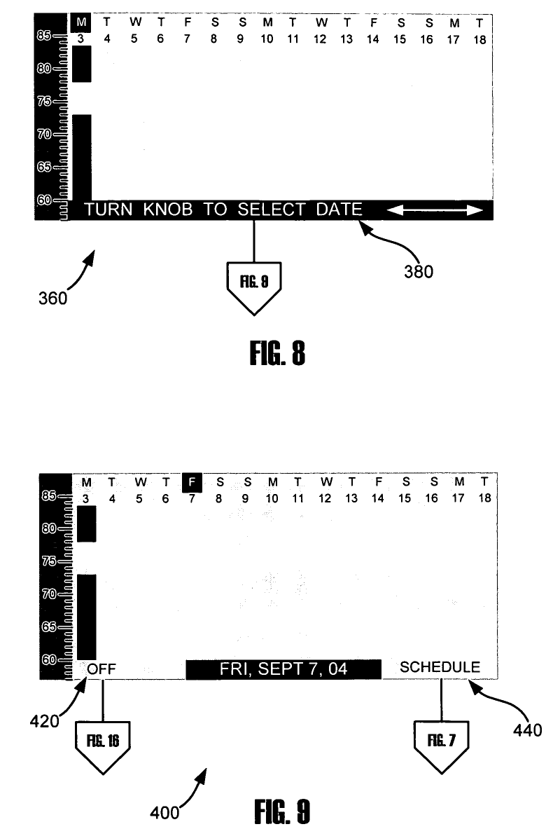

The Date button 260 and End button 300 will be described with reference to FIGS. 8 and 11. Briefly, the Date button 260 allows a user to program the graphical thermostat and sensor 10 for a user-selected date, and the End button 300 allows the user to select the stop, or end time, for a given date. Upon pressing the Date button 260, the LCD display 12 presents the interface 360 illustrated in FIG. 8. This interface 360 illustrates the current date by highlighting a vertical region below the date, shown on the horizontal axis along the top of the display. The interface 360 includes an instruction 380 for the user to turn the knob right or left to adjust the date the user wishes to program. Upon turning the control knob 14, the interface 400 illustrated in FIG. 9 is activated. The interface of FIG. 9 is essentially the same screen as shown in FIG. 8. However, the interface 400 illustrates the selected date (selected by turning the control knob 14) at both the top of the display and at the bottom of the display. In particular, the user-selected date is highlighted at the top of the display and the full title corresponding to that date is presented at the bottom and center of the display. In the illustrative embodiment of FIG. 9, the user has turned the control knob to select Friday, September 7^{th}.

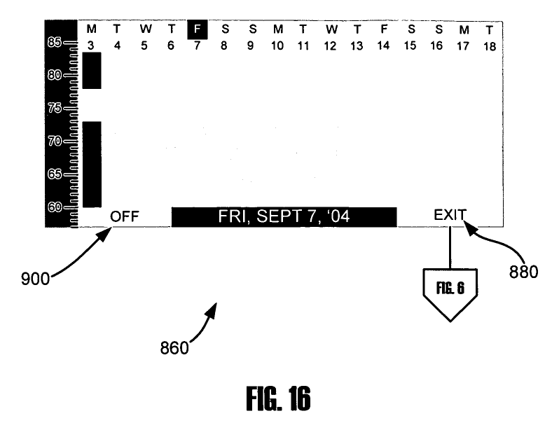

The date selection interface 400 of FIG. 9 includes two buttons, including an Off button 420 and a Schedule button 440. According to one aspect of the invention, the Off button 420 will be displayed only if the user-selected date is the current date. If that is the case, and the Off button 420 is selected, the user is shown the interface 860 displayed by FIG. 16. According to one aspect of the present invention, in that interface 860, depressing the Off button again will turn off the system for the current day. This may be overridden by the begin button of FIG. 6. When the user presses the Exit button 880, the user provided with the start interface 220 illustrated in FIG. 6.

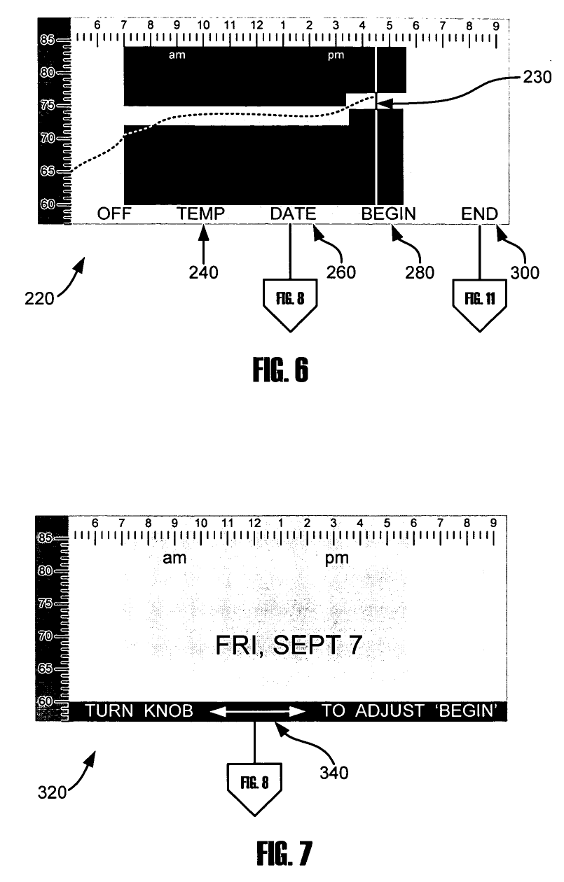

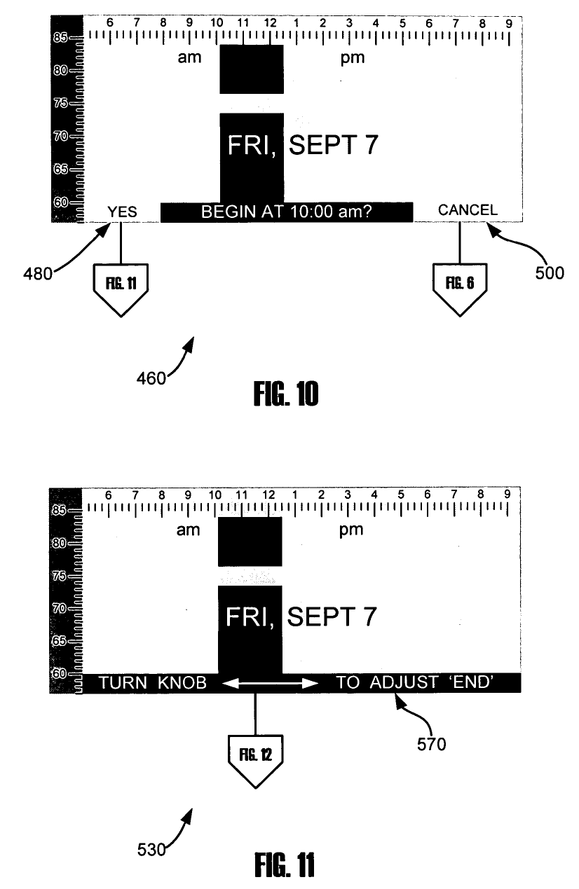

Referring again to FIG. 9, upon pressing the Schedule button 440 (i.e., the button directly underneath “Schedule”, or “Schedule” if the display is touch sensitive), the user is presented with the schedule interface of FIG. 7, which confirms the user selected date and instructs the user 340 to turn the knob 14 to adjust the temperatures and start and stop time for that date. Upon turning the knob 14, as indicated by the instruction 340, the user is provided with the begin interface 460 shown in FIG. 10. This interface graphically illustrates, using the shaded area, the begin time at which the graphical thermostat and sensor 10 will begin regulating the temperature to the user-selected temperature for that given date. The user-selected temperature is set using the control knob 14. Because the shaded region defaults such that it shows an end or stop time two hours from the begin or start time, the shaded region illustrates the horizontal temperature bar. The user may adjust this temperature bar by turning the control knob 14. If the cancel button 500 is selected, the user is returned to the start interface 220. Otherwise, if the Yes button 480 is selected, the user is presented with the interface of FIG. 11.

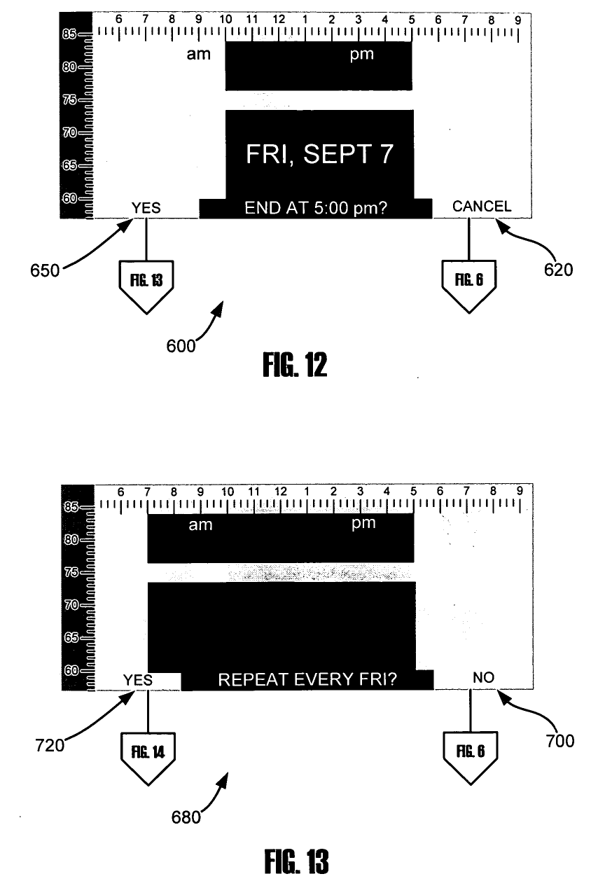

The end interface 530 of FIG. 11 operates like the interface of FIG. 7, but for the fact that it displays the shaded region indicating the start/begin time. Therefore, FIG. 11 displays an instruction 570 to the user to adjust the knob 14 to adjust the end time. Upon turning the knob 14, the user is presented with the interface of FIG. 12. The interface 600 of FIG. 12 graphically illustrates the selected start/begin times and stop/end times by showing the region between those times as a shaded region. The user-selected temperature (or range around the user-selected temperature) is also displayed as an unshaded horizontal bar. This temperature may also be altered at this interface 600. To save the programming for the selected day, the user can press the Yes button 650. Alternatively the user can depress the Cancel button 620 to return to the start interface 220.

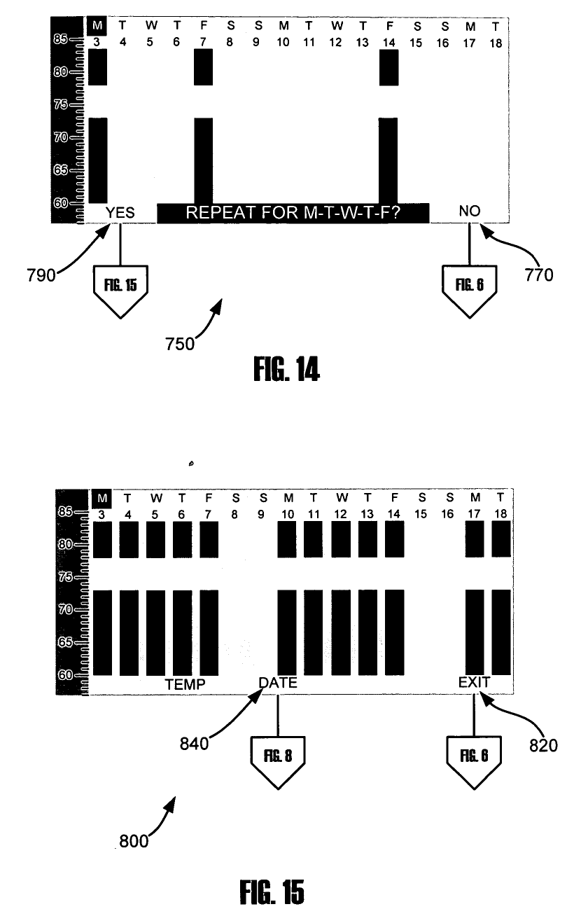

If the Yes Button 650 of interface 600 is selected, the user is presented with an interface 680, illustrated in FIG. 13, which asks the user if the user wishes the setting for the user-selected day to be set for the same day in future weeks. In the illustrative example of FIG. 13, because the user is programming the temperature for a Friday, the interface 680 asks the user if the temperature setting, and start/begin and stop/end times, should be repeated for every Friday. If the user selects the No button 700, the settings for the day are saved and the user is returned to the start interface 220. On the other hand, if the user selects the Yes button 720, the user is presented with the interface of FIG. 14.

FIG. 14 graphically illustrates the additional days for which the setting will be saved. According to one aspect of the present invention, the display 12 shows at least one additional week along the top of the display 12 using numbers corresponding to the days of the month, and letters corresponding to the days of the week. The interface 750 of FIG. 14 asks the user if the user-selected temperature and start/begin and stop/end settings should be repeated for each weekday. If the user selects the No button 770, the user is returned to the start interface 220. If the user selects the Yes button 790, the user is presented with the interface 800 of FIG. 15. The interface 800 of FIG. 15 graphically shows that the settings are effective for each weekday. The user can select the Date button 840 to edit or alter a specific day. Therefore, upon depressing the Date button 840 the user is presented with the interface 360 illustrated in FIG. 8. Alternatively, the user can press the Exit button 820 to return to the start interface 220.

Finally, referring again to the End button 300 of the start interface 220, the end button allows a user to modify the end/stop time of the current days' program. To effect this function, the user is presented with the interface 530 of FIG. 11, where the interface presents the user with the shaded region for the present day. Using the interface 530, the user can adjust the stop/end time for the present day.

It will be appreciated that the present invention therefore provides a user with a simultaneous graphical representation of the times during the day at which the system should run, with the desired temperature, and a dashed line representing the actual temperature throughout the run time. Furthermore, the present invention provides intuitive and easy to use graphical interfaces and controls to adjust the start/begin and stop/end times, and temperature, for any date. Moreover, the graphical thermostat and sensor 10 can communicate the settings, the actual temperature, or an indication that the actual temperature has fallen outside of an acceptable range of user-selected temperature, electronically to an operator display or save such information in a log so that the performance of the HVAC system can be monitored.

Many modifications and other embodiments of the inventions set forth herein will come to mind to one skilled in the art to which these inventions pertain having the benefit of the teachings presented in the foregoing descriptions and the associated attachments. Therefore, it is to be understood that the inventions are not to be limited to the specific embodiments disclosed and that modifications and other embodiments are intended to be included within the scope of the present disclosure. For instance, the term thermostat has been used herein to reference a general comfort control device, and is not intended to be limiting in any way. For example, in addition to traditional thermostats, devices of the present invention could be a humidistat or used for venting control. Therefore, although specific terms are employed herein, they are used in a generic and descriptive sense only and not for purposes of limitation.

That which is claimed:

1. A method of facilitating the control of a thermostat, comprising:
providing at least one display, wherein the at least one display is operable to illustrate, on a first axis, a range of temperatures, and on a second axis, a range of times; and
illustrating on the at least one display at least one shaded area, said at least one shaded area defining a temperature differential centered about a temperature set by a user.

2. The method of claim 1, further comprising the step of presenting, on the at least one display, a line indicating the past temperature of at least one area in which the at least one display resides.

3. The method of claim 2, further comprising the step of showing a user-selectable future date on the at least one display.

4. The method of claim 1, further comprising the step of showing the present time on the at least one display using a time line, wherein the time line intersects the range of times provided on the second axis.

5. The method of claim 4, further comprising the step of providing at least one function button on the at least one display, wherein the at least one function button is selectable by a user.

6. The method of claim 4, further comprising the step of receiving a user input from a rotating control knob.

7. The method of claim 6, wherein the user input received from the rotating control knob increases or decreases the current temperature.

8. The method of claim 1, further comprising the step of measuring a temperature local to the at least one display using a temperature sensor.

9. The method of claim 8, further comprising the step of reporting the temperature local to the at least one display to a device located remote from the at least one display.

10. The method of claim 9, wherein the step of reporting further comprises the step of communicating with the device via a network interface.

11. The method of claim 1, further comprising the step of receiving a range of temperatures selected by a user, said range of temperatures highlighted by the user and displayed on the at least one display.

12. The method of claim 1, further comprising the step of receiving a range of dates selected by a user, said range of dates highlighted by the user and displayed on the at least one display.

13. A computer program product for permitting the graphic control of a thermostat, said computer program product comprising:
a computer usable medium having computer-readable code means embodied in said medium, said computer-readable code means comprising:
computer readable program code means for presenting, on at least one display, a range of temperatures on a first axis, and a range of times on a second axis; and
computer readable program code means for illustrating on the at least one display at least one shaded area, said at least one shaded area defining a temperature differential centered about a temperature set by a user.

14. The computer program product of claim 13, further comprising computer readable program code means for displaying a line indicating the past temperature of at least one area in which the at least one display resides, as measured by a temperature sensor local to the at least one display.

15. The computer program product of claim 13, further comprising computer readable program code means for showing the present time on the at least one display using a time line, wherein the time line intersects the range of times provided on the second axis.

16. The computer program product of claim 13, further comprising computer readable program code means for reporting the temperature local to the at least one display to a device located remote from the at least one display.

17. The computer program product of claim 16, further comprising computer readable program code means for communicating with the device located remote from the at least one display via a network interface.

18. A graphical thermostat, comprising:
at least one display, wherein the at least one display is operable to illustrate, on a first axis, a range of temperatures, and on a second axis, a range of times; and
a graphical thermostat module, said graphical thermostat module operable to present at least one shaded area on the at least one display, said at least one shaded area defining a temperature differential centered about a temperature set by a user.

19. The graphical thermostat of claim 18, further comprising a communications jack that permits communication with an HVAC system in communication with the graphical thermostat.

20. The graphical thermostat of claim 18, further comprising a temperature sensor and a network interface in communication with the temperature sensor.
